(19) United States
(12) Patent Application Publication
(10) Pub. No.: US 2005/0157196 A1
(43) Pub. Date: Jul. 21, 2005

(54) Image photographing apparatus

(75) Inventors: Min-Ho Cha, Seoul (KR); Yong-Il An, Goyang-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/034,929

(22) Filed: Jan. 14, 2005

(30) Foreign Application Priority Data
Jan. 19, 2004 (KR) 2004-3898

(51) Int. Cl. H04N 5/222

(52) U.S. Cl. 348/333.06

(57) ABSTRACT

An image photographing apparatus comprises a casing having an open end. A main body movably mounted with respect to the casing and has a camera unit for obtaining image information. A storage medium is provided for storing the obtained information, and a display panel is movably mounted to the main body.

### CROSS-REFERENCE TO RELATED APPLICATIONS

This application claims the benefit under 35 U.S.C. § 119(a) of Korean Patent Application No. 2004-3898, filed Jan. 19, 2004, in the Korean Intellectual Property Office, the entire disclosure of which is hereby incorporated by reference.

### BACKGROUND OF THE INVENTION

1. Field of the Invention

The present invention relates to an image photographing apparatus. More particularly, the present invention relates to an image photographing apparatus for recording and reproducing image information that minimizes size and is light weight for improved portability and convenience.

2. Description of the Related Art

Generally, camcorders for photographing still and moving images are widely known as a representative example of image information recording and reproducing apparatuses. The camcorder comprises a lens device, a signal converting device, a deck device for recording and reproducing a photographed image, and a display device. Typically, a cassette tape is used as a recording medium in the camcorder for recording information of the photographed image. Unfortunately, conventional recording and reproducing apparatuses are bulky and cumbersome to use. Therefore, recently, research on smaller and lighter image information recording and reproducing apparatuses which use a hard disc drive is progressing as life styles and living patterns of people change.

Accordingly, there is a need for an improved an image photographing apparatus for recording and reproducing image information that is smaller, lighter, and more convenient to use.

### SUMMARY OF THE INVENTION

An aspect of the present invention is to solve some of the aforementioned problems and/or disadvantages and to provide other advantages that will be appreciated by those of ordinary skill in the art. Accordingly, embodiments of the present invention provide an image photographing apparatus which is compact, minimizes size, and is light weight for improved portability and convenient use.

The foregoing and other objects and advantages are substantially realized by providing an image photographing apparatus comprising a casing having first and second ends of which one end is open, a main body movably positionable between a substantially inserted position within the casing and a substantially retracted position outside the casing. The main body has a camera unit for obtaining image information and a storage medium for storing the obtained information, and a display panel movably mounted to the main body.

The image photographing apparatus further comprises a holding unit for maintaining an inserted state of the main body in the casing.

The holding unit preferably comprises magnets disposed on an inner bottom of the casing and a bottom of the main body to correspond to each other and connected with each other by magnetic force.

The image photographing apparatus further comprises an automatic withdrawal unit for automatically pushing the main body outward from the casing when separating the main body by the holding unit.

The automatic withdrawal unit comprises at least one guide rail mounted in the casing; and a spring mounted in the casing and compressed by the main body being inserted in the casing.

A lens part is formed at the camera unit, such that the lens part is covered when the main body is inserted in the casing and is exposed when the main body is withdrawn.

The main body comprises a recording button.

The display panel is mounted on an upper part of the main body to bi-axially rotate.

The display panel rotates with respect to a first axis by approximately 180° and rotates with respect to a second axis by approximately 315°.

The display panel is exposed out of the casing when the main body is inserted in the casing.

When the display panel covers one side of the main body, a predetermined gap is formed between the display panel and the one end.

Other objects, advantages, and salient features of the invention will become apparent to those skilled in the art from the following detailed description, which, taken in conjunction with the annexed drawings, discloses preferred embodiments of the invention.

### BRIEF DESCRIPTION OF THE DRAWING FIGURES

The above aspects and other features of the present invention will become more apparent from the following detailed description of exemplary embodiments taken in conjunction with the accompanying drawings, in which:

FIG. 1 is a perspective view showing an image photographing apparatus in accordance with an embodiment of the present invention;

FIG. 2 is a perspective view showing a main body of FIG. 1 inserted in a casing;

FIG. 3 is a perspective view of the image photographing apparatus of FIG. 1 in use;

FIG. 4 is a front view of the image photographing apparatus of FIG. 1; and

FIG. 5 is a view schematically showing the structure of the image photographing apparatus of FIG. 1.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that a various changes and modifications of the embodiments described herein can be made without departing from the scope and spirit of the invention. Also, descriptions of well-known functions or constructions are omitted for conciseness.

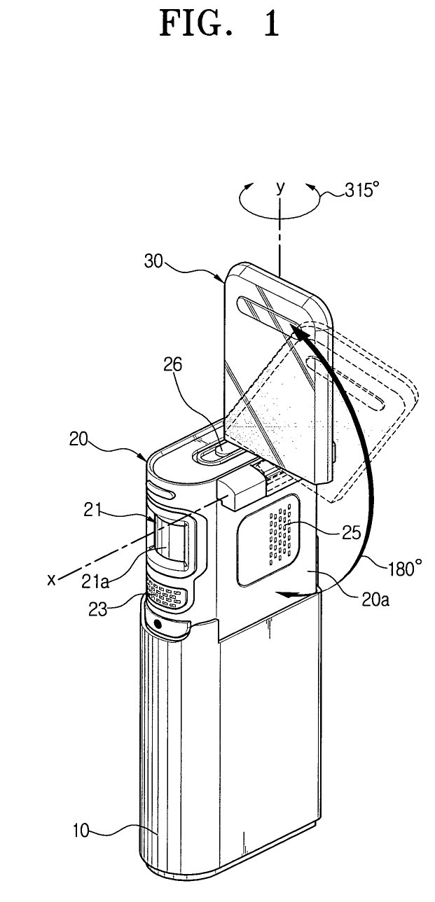

Referring to FIG. 1, an image photographing apparatus according to an exemplary embodiment of the present invention comprises a casing 10 having first and second ends, of which one end is open, a main body 20 movable in and out with respect to the casing 10, and a display unit 30 movably mounted to the main body 20.

The casing 10 has a space therein of a predetermined size for receiving the main body 20. A top portion of the casing 10 is open. The main body 20 is mounted through the open top for sliding a predetermined distance. The casing 10 functions as a receiving part for protecting the main body 20. The casing 10 is made of a substantially thin and substantially light material, for example, metal containing aluminum or stainless steel.

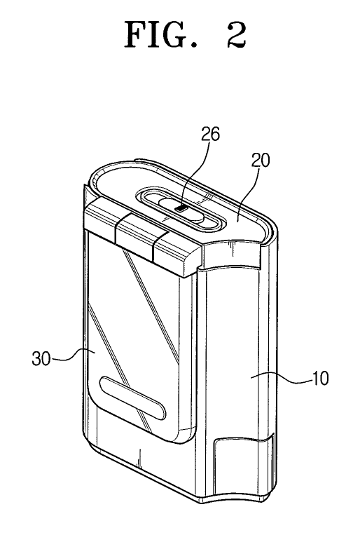

The main body 20 comprises a camera unit 21 for obtaining image information and a storage medium (not shown) for storing the obtained information. The camera unit 21 is disposed on an upper part of the main body 20 to obtain image information through a lens part 21a which is exposed. When the main body 20 is inserted in the casing 10, as shown in FIG. 2, the lens part 21a is covered up by the casing 10.

Therefore, in a state as shown in FIG. 2, photographing is not performed, but parts of the main body 20 including the camera unit 21 are safely protected inside.

Since the storage medium (not shown) is built in the main body 20, a hard disc drive, a flash memory, or a memory stick can generally be used. The storage medium stores the image information obtained through the camera unit 21 and other various program information. Since the mounting structure and the operation of the storage medium are conventional, detailed description thereof will be omitted herein.

A microphone unit 23 is provided in the vicinity of the camera unit 21. A speaker 25 is provided on one end of the main body 20. The microphone unit 23 and the speaker 25 can also go into the casing 10, thereby being protected from dust or foreign substances.

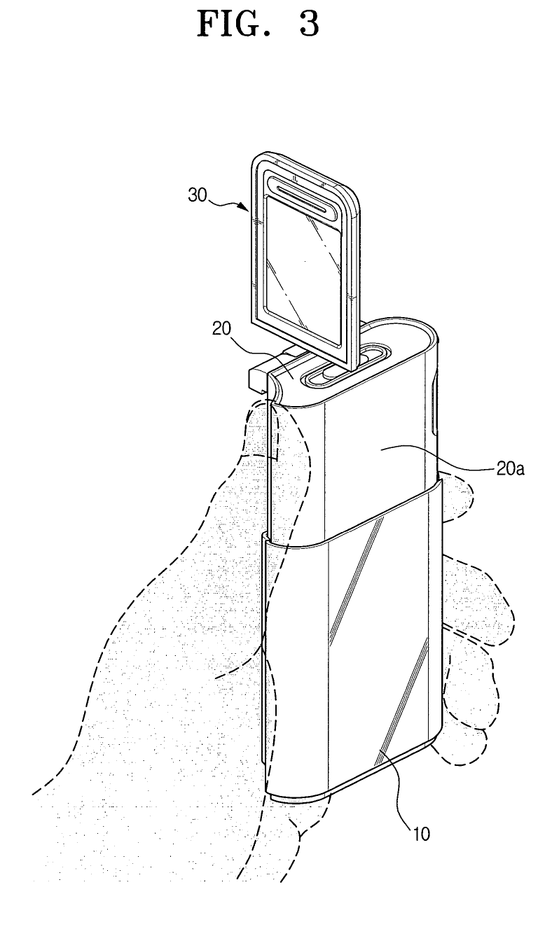

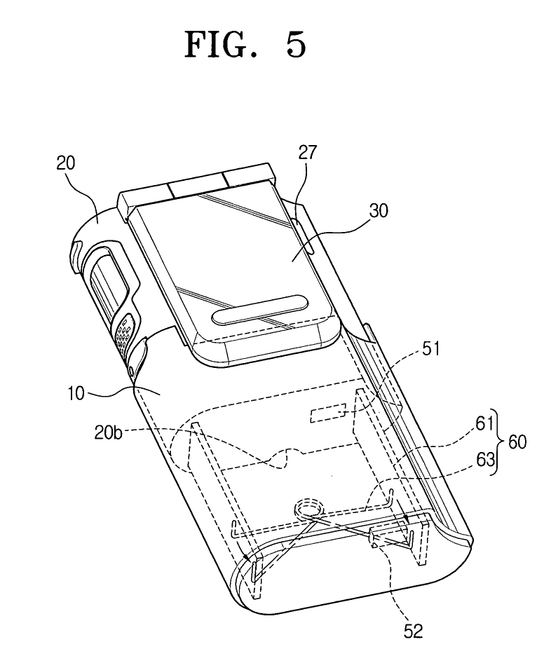

In addition, a recording button 26 is provided on an upper part of the main body 20. As shown in FIG. 5, a zoom button 27 is formed on the opposite side from the camera unit 21. Therefore, when the main body 20 is withdrawn out of the casing 10, a user can operate the zoom button 27 with his or her thumb regardless of whether the user is right-handed or left-handed. FIG. 3 illustrates an example of using the image photographing apparatus with the left hand.

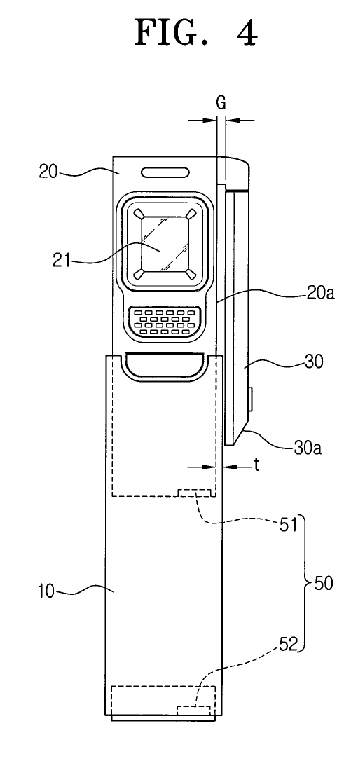

The display panel 30 is mounted to an upper part of the main body 20 for bi-axial rotation. The display panel 30 rotates with respect to a first axis (x) approximately 180° and rotates with respect to a second axis (y) approximately 315°. Further, as shown in FIG. 4, the display panel 30 covers one side 20a of the main body 20, and a predetermined gap G is formed between the display panel 30 and the one side 20a. The gap G preferably has thickness corresponding to thickness (t) of the casing 10. Thus, the display panel 30 can be disposed at the outside of the casing 10, while the main body 20 is covered by the display panel 30, and inserted in the casing 10. Therefore, the user can withdraw the main body 20 from the casing 10 simply by pushing upward on a lower end 30a of the display panel 30.

As shown in FIG. 4, a holding unit 50 may be provided to maintain insertion of the main body 20 into the casing 10. The holding unit 50 preferably comprises a pair of magnets 51 and 52 disposed on an inner bottom of the casing 10 and a bottom of the main body 20, corresponding to each other, respectively. When the magnets 51 and 52 are in contact with each other, the main body 20 cannot easily escape from the casing 10 due to attraction between the magnets. The user must separate the magnets 51 and 52 by pushing up the lower end 30a of the display panel 30 to overcome the attractive force of the magnets, thereby withdrawing the main body 20 from the casing 10.

More preferably, an automatic withdrawal unit 60 may be provided, as shown in FIG. 5. The automatic withdrawal unit 60 assists the main body 20 by semi-automatically withdrawing the main body 20 from the casing 10 when released from the holding unit 50. The automatic withdrawal unit 60 comprises a guide rail 61 and a spring 63 both mounted in the casing 10. The guide rail 61 is preferably formed in a pair and vertically mounted in the casing 10, in a side by side orientation. A pair of guide slits is formed in the main body 20 to correspond to the guide rails 61. Both ends of the spring 63 are extended toward the guide rail 61. When the main body 20 is inserted in the casing 10, a lower end of the main body 20 is contacted with an end of the spring 63, thereby elastically transforming the spring 63. Accordingly, the spring 63 is transformed elastically and pushes the main body 20 upward in a withdrawal direction from the main body 20. Therefore, when the holding units 51 and 52 are separated, the main body 20 is substantially semi-automatically withdrawn along the guide rails 61 by a recovering force of the spring 63. Additionally, a spring escaping space 20b is formed in the main body 20 for avoiding interference by the spring 63.

As can be appreciated from the above description, the image photographing apparatus according to an exemplary embodiment of the present invention may be carried with the main body 20 having the camera unit 21 inserted in the casing 10. Accordingly, the image photographing apparatus is protected from an external impact or foreign substances, and also has improved portability.

Moreover, since the main body 20 is automatically withdrawn from the casing 10 by the automatic withdrawal unit 60, convenient use as well as a sleek and simple appearance is achieved.

Furthermore, since the display panel 30 is disposed on the upper part of the main body 20, a rotation range thereof is extended compared to conventional camcorders, thereby enabling another convenient application.

While the invention has been shown and described with reference to certain embodiments thereof, it will be understood by those skilled in the art that various changes in form and details may be made therein without departing from the spirit and scope of the invention as defined by the appended claims.

1. An image photographing apparatus comprising:
a casing having first and second ends, one of the first and second ends being open;
a main body movably positionable between a substantially inserted position within the casing and a substantially extended position outside of the casing, the main body having a camera unit for obtaining image information, and a storage medium for storing the obtained information; and
a display panel movably mounted to the main body.

2. The image photographing apparatus of claim 1, further comprising
a holding unit for releasably securing the main body within the casing.

3. The image photographing apparatus of claim 2, wherein
the holding unit comprises magnets disposed on an inner bottom of the casing and a bottom of the main body, the magnets corresponding to one another and connected with each other by a magnetic force.

4. The image photographing apparatus of claim 2, further comprising
a withdrawal unit for facilitating pushing of the main body from the substantially inserted position to the substantially extended position outward from the casing as the main body is separated from the holding unit.

5. The image photographing apparatus of claim 4, wherein
the withdrawal unit comprises at least one guide rail mounted in the casing; and
a spring mounted in the casing, wherein the spring is adapted to be compressed by the main body as the main body is moved to the substantially inserted position within the casing.

6. The image photographing apparatus of claim 1, wherein
a lens part is formed on the camera unit, so that the lens part is covered when the main body is in the substantially inserted position within the casing and is exposed when the main body is is in the substantially extended position outside of the casing.

7. The image photographing apparatus of claim 1, wherein
a recording button is disposed on the main body.

8. The image photographing apparatus of claim 1, wherein
the display panel is mounted on an upper part of the main body for bi-axial rotation.

9. The image photographing apparatus of claim 8, wherein
the display panel rotates with respect to a first axis by approximately 180° and rotates with respect to a second axis by approximately 315°.

10. The image photographing apparatus of claim 1, wherein
the display panel is exposed when the main body is in the substantially inserted position within the casing.

11. The image photographing apparatus of claim 10, wherein,
when the display panel covers one of the first and second ends of the main body, a predetermined gap is formed between the display panel and the one end.
